(19) United States
(12) Patent Application Publication
(10) Pub. No.: US 2009/0129301 A1
(43) Pub. Date: May 21, 2009

(54) Configuring a user device to remotely access a private network

(75) Inventor: Petros Belimpasakis, Tampere (FI)

Correspondence Address: Hollingsworth & Funk, LLC, 8009 34th Avenue South, Suite 125, Minneapolis, MN, 54425, US

(73) Assignee: Nokia Corporation and Recordation

(21) Appl. No.: 11/985,512

(22) Filed: Nov. 15, 2007

(51) Int. Cl. H04B 7/00

(52) U.S. Cl. 370/310

(57) ABSTRACT

Configuring a mobile device to remotely access a private network involves determining, via the private network, first network parameters that enable the mobile device utilize to a computing service of the private network. The device also determines, via a gateway coupled to the private network, second network parameters that allow the mobile to utilize the computing service via a public network. The first and second network parameters are stored on the mobile device. A request is received from a user of the mobile device to access the computing service. It is determined that the mobile device is not on the private network. In response to determining that the mobile device is not on the private network, the second network parameters are utilized to access the computing service via the gateway in response to the request.

### FIELD OF THE INVENTION

This invention relates to private network access through firewalls.

### BACKGROUND OF THE INVENTION

Mobile communications devices such as cell phones increasingly include advanced data processing and communications capabilities. Far from being simple voice communications tools, modem mobile devices may include many different capabilities, such as email, text messaging, Web browsing, digital photography, sound recording/playback, location awareness, etc. As such, these devices are gaining ever-wider acceptance and are become increasingly valuable to end-users.

In order to increase the bandwidth available to mobile device users, mobile network providers and mobile device manufacturers are transitioning to third-generation (3G) technologies. The designation 3G refers to a collection of standards and technologies that can be used in the near future to enhance performance and increase data speed on cell phone networks. In particular, 3G is an International Telecommunication Union (ITU) specification for the third generation of mobile communications technology. A 3G cell phone would, in theory, be compatible with the 3G standards which support enhanced data speeds.

Besides communicating over provider networks, 3G devices may also be equipped with computer network interfaces (e.g., WiFi, Bluetooth, WiMax, etc) that allow the device to communicate locally with other consumer electronics devices in a user's home or workplace. For example, a standard known as Universal Plug and Play™ (UPnP) provides a way for disparate processing devices to exchange data via a home network. The UPnP specification includes standards for service discovery, and is mainly targeted for proximity or ad hoc networks. Various contributors publish UPnP device and service descriptions, thus creating a way to easily connect devices and simplifying the implementation of networks. It is the goal of UPnP to enable home electronics to seamlessly interact, thus furthering the usefulness of such devices. Because a mobile communications device can also be configured to communicate using home network media and protocols, it is possible for such devices to communicate via UPnP networks.

Such network-aware devices may also be able to access home devices using other well-known protocols. For example, home computers may act as file servers using network file protocols such as Server Message Block (SMB), Network File System (NFS), Andrew File System (AFS), etc. These network file protocols allow client computers to access files from a network server using the same commands and user interface used to access local files. Other service protocols such as Hypertext Transport Protocol (HTTP), File Transfer Protocol (FTP), may server similar functions, allowing multiple devices to access stored data on one or more servers.

Devices on home networks may access external networks, in particular the Internet, by way of a gateway device that is coupled to both the home network and the Internet. In order to allow multiple devices to access the Internet without having to supply each device with a unique address (which might not be possible, due to limited amount of unique addresses) a gateway device may utilize Network Address Translation (NAT). A gateway using NAT may be referred to herein as a NAT firewall, or simply NAT. A NAT firewall will create and maintain mappings between Internet Protocol (IP) addresses and ports of a local network and addresses and ports of an external, public network.

Typically, the NAT firewall will have a single address on the public network, and the NAT firewall may be the only device on the home network assigned with a public IP address. The NAT may be setup as the default route on the home network, and will reassign TCP and UDP ports on the external side of the connection when connecting to external hosts. On the internal side of the NAT, users preferably configure the local network to use non-Internet routable IP addresses (e.g., 10.0.0.0/8, 192.168.0.0/16) as defined by the Internet Engineering Task Force (IETF). The use of private address spaces assures that there will be no conflict with public IP addresses when traffic needs to be routed outside the home network.

Usually the NAT maps the private and public addresses/ports based on a request that originated from the private network. The NAT receives outgoing connection requests, and remaps the data in the TCP headers to include the NAT IP address and a randomly generated source port. When receiving returned data from the public network, the NAT will look at the TCP/UDP port numbers of the incoming data and determine whether the port matches one of the random ports, in which case the target IP address and port on the internal network can be determined. The NAT will change this value in the IDP/IP or TCP/IP headers, and forward the incoming data to the local network.

Any incoming connection requests to the NAT's externally interface (e.g., connection requests that originate from the Internet) are usually blocked by the firewall, unless there has been a predefined mapping of TCP/UDP port to an internal device. This can sometimes make it difficult for a novice user to set up an externally accessible network service on their home network. Although the NAT firewall usually has a user interface that allows manually mapping the internal address to a service port, many users are not aware of this user interface, or of how to access or configure it.

Further, the users may not understand the difference between accessing a home service locally verses remotely. For example, the user may be able to access a service directly in the private network by way of a hostname, but may need a different hostname-port or IP address-port to access the service remotely. The use of different hostnames depending on location may make it cumbersome to use some application on mobile devices, which routinely transition between private and public networks. The present disclosure is directed to these and other deficiencies in the prior art.

### SUMMARY OF THE INVENTION

To overcome limitations in the prior art described above, and to overcome other limitations that will become apparent upon reading and understanding the present specification, the present invention discloses a system, apparatus and method for configuring a user device to remotely access a private network.

In accordance with one embodiment of the invention, an apparatus includes at least one network interface, memory, and a processor coupled to the memory and the network interface. The memory stores instructions that cause the processor to, while on the private network, determine first network parameters that enable the apparatus to utilize a computing service of the private network. While on the private network, the instructions further cause the processor to determine, from a gateway coupled to the private network and the public network, second network parameters that allow the apparatus to utilize the computing service via the public network. The gateway selectably blocks connection attempts from the public network to the private network. While on the public network, the instructions cause the processor to receive a request from the user interface to access the computing service, and determine that the apparatus is not on the private network. The instruction further cause the processor to utilize the second network parameters to access the computing service via the gateway in response to determining that the apparatus is not on the private network.

In a more particular embodiment, the instructions cause the processor to determine that the apparatus is not on the private network by comparing network configuration parameters received via the public network to analogous network configuration parameters of the private network. Comparing network configuration parameters received via the public network may involve analyzing current Internet protocol configuration data of the network interface to determine that the current Internet protocol configuration data is different than Internet protocol configuration data of the private network. In another case, comparing network data received via the network interface may involve analyzing a current service set identifier of a wireless access point to determine that the current service set identifier is different than a service set identifier of the private network.

In other more particular embodiments, the instructions cause the processor to determine that the apparatus is not on the private network by determining a location of the apparatus. In one arrangement, the private network includes a Universal Plug and Play network, and the apparatus determines the second network parameters from a Universal Plug and Play Internet Gateway Device interface of the gateway. In another arrangement, the instructions cause the processor to determine that the apparatus is not on the private network in response to a failure of a connection attempt made using the first network parameters. In yet another arrangement, the gateway includes a network address translation gateway, and the second network parameters include an IP address and port mapping usable by the network address translation gateway.

In another embodiment of the invention, a method involves determining, via a private network, first network parameters that enable the mobile device utilize to a computing service of the private network. Second network parameters are determined via a gateway coupled to the private network and the public network. The second network parameters allow the mobile to utilize the computing service via the public network, and the gateway selectably blocks connection attempts from the public network to the private network. The method further involves storing the first and second network parameters on the mobile device, and receiving a request from a user of the mobile device to access the computing service. The mobile device determines that the mobile device is not on the private network. In response to determining that the mobile device is not on the private network, the second network parameters are utilized to access the computing service via the gateway in response to the request.

In more particular embodiments of the method, determining that the mobile device is not on the private network involves comparing current network configuration parameters received via the public network with analogous network configuration parameters of the private network. In such a case, comparing network configuration parameters received via the public network may involve analyzing current Internet protocol configuration data of the network interface to determine that the current Internet protocol configuration data is different than Internet protocol configuration data of the private network. In a particular arrangement, comparing network configuration parameters received via the public network involves analyzing a current service set identifier of a wireless access point to determine that the current service set identifier is different than a service set identifier of the private network.

In other more particular embodiments, determining that the apparatus is not on the private network involves determining a location of the apparatus. In one configuration, the private network includes a Universal Plug and Play network, and the second network parameters are determined from a Universal Plug and Play Internet Gateway Device interface of the gateway. In another configuration, determining that the apparatus is not on the private network comprises determining a failure of a connection attempt made using the first network parameters. The may include a network address translation gateway, and in such a case the second network parameters include an IP address and port mapping usable by the network address translation gateway.

In another embodiment of the invention, a system includes a gateway capable of being simultaneously coupled to a private network and a public network. The gateway selectably blocks connection attempts from the public network to the private network. The system includes a mobile terminal capable of communicating on the private network public networks. The mobile terminal includes at least one network interface, memory, and a processor coupled to the memory and the network interface. The memory stores instructions that cause the processor to, while on the private network, determine first network parameters that enable the mobile terminal utilize to a computing service of the private network, and determine, via the gateway, second network parameters that allow the mobile terminal to utilize the computing service via the public network. While on the public network, the instructions cause the processor to receive a request to access the computing service, determine that the mobile terminal is not on the private network, and utilize the second network parameters to access the computing service via the gateway in response to determining that the apparatus is not on the private network. The private network may include a Universal Plug and Play network, and in such a case, the second network parameters are determined from a Universal Plug and Play Internet Gateway Device interface of the gateway.

In another embodiment of the invention, a computer-readable storage medium includes instructions executable by a processor of a mobile terminal. While on a private network, the instructions cause the processor to: 1) determine first network parameters that enable the mobile terminal to utilize a computing service of the private network; and 2) determine, from a gateway coupled to the private network and the public network, second network parameters that allow the mobile terminal to utilize the computing service via the public network. The gateway selectably blocks connection attempts from the public network to the private network. While on the public network, the instructions cause the processor to: 1) receive a request from the user interface to access the computing service; 2) determine that the mobile terminal is not on the private network; and 3) utilize the second network parameters to access the computing service via the gateway in response to determining that the apparatus is not on the private network.

In another embodiment of the invention, an apparatus includes: 1) means for determining, while on a private network, first network parameters that enable the apparatus to utilize a computing service of the private network; 2) means for determining, while on the private network from a gateway coupled to the private network and a public network, second network parameters that allow the apparatus to utilize the computing service via the public network; 3) means for receiving, while on the public network, a request from a user of the apparatus to access the computing service; 4) means for determining that the apparatus is not on the private network while on the public network; and 5) means for utilizing the second network parameters to access the computing service via the gateway in response to determining that the apparatus is not on the private network.

These and various other advantages and features of novelty are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams.

FIG. 1 is a block diagram illustrating a system according to embodiments of the invention;

FIGS. 2 and 3 are block diagrams showing connection scenarios for a mobile device according to embodiments of the invention;

FIGS. 4 and 5 are block diagrams illustrating various mobile client implementations according to embodiments of the invention;

FIG. 6 is a sequence diagram showing interactions between components according to an embodiment of the invention;

FIG. 7 is a block diagram of a mobile computing arrangement according to embodiments of the invention;

FIG. 8 is a block diagram of a gateway according to embodiments of the invention; and

FIG. 9 is a flowchart showing a procedure according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to automatic configuration of user devices to seamlessly access home network services whether inside of or outside of the local home environment. Generally this may involve determining firewall port mappings, and using a different, external, address/port combination if it is determined that the user device is not currently on the home network. The user device may also be able automatically enable and disable the mappings on a gateway device on an as-needed basis.

In a large number of networked homes, the individual home devices cannot be accessed from the public Internet. Thus, the user cannot connect remotely (using a mobile phone, office computer, etc.) to one of the in-house devices (e.g. home computer) for controlling the in-house device or accessing its content. There are a number of different ways to remotely access a home service. One solution involves the establishment of Virtual Private Networks (VPN). A VPN is “tunnel” through the public networks that is established between an external client and the home gateway. The tunnel typically uses a TCP/IP socket that is established using a public IP address. The gateway assigns an IP address of the private network to the client, and the client uses this address to create a virtual network interface having the private IP address. The socket is used to pass (usually encrypted) traffic between the socket endpoints. Software at the socket endpoints performs actions such as decrypting packets and routing the traffic on the private network.

When using a VPN, it appears to the remote computer that the remote computer is physically connected to the local network, even though the actual network interface hardware (e.g., Ethernet, WiFi, 3G) is connected to a different network. Similarly, other devices on the home network can find the remote client, although possibly with an IP address that is different than what might be assigned if the device was local. This is because the VPN IP address is provided by the VPN gateway device, and may be assigned using different address ranges that what might be used in a local address assignment (e.g., via DHCP or static address setting).

Nonetheless, a VPN has the advantage of allowing a remote device to access a home server using the same IP address, both within home network and from an external network. However, it can be complicated to configure a VPN. There are numerous VPN security protocols (e.g., IPSec, PPTP, etc), authentication modes (shared keys, network account authentication, biometrics, etc.), and encryption modes to choose from. Access to the VPN often requires special software (e.g., VPN end-points) to be installed on client devices. Further, most home NAT gateways do not provide a VPN feature, thus users might have to upgrade to more costly hardware in order to take advantage of a VPN.

As described above, port forwarding from a NAT firewall/gateway (e.g. gateway 102) is another technology that allows devices to access private networks from public networks. This generally involves mapping an external IP address and port with an internal IP address and port. Any incoming service requests on that port are received by the gateway, the headers are changed to conform to the local hostname and port, and the request is forwarded to the local target. Port forwarding a simple and commonly deployed solution. It is available on most NAT/gateways, and does not require any new protocols or software be installed on the end devices. Port forwarding works with most IP based protocols, and in particular TCP/IP and UDP/IP.

One issue with using port forwarding is that it requires configuration of the gateway. This configuration can be difficult for those without some basic understanding of network concepts, and in particular an understanding of how port forwarding works and why it is necessary. Such configuration is made much easier in UPnP Internet Gateway Device (IGD) implementations that allow the port forwarding to be programmatically enabled via the network. Extensions to UPnP IGD v.1.0 & v.2.0 may allow any UPnP Control Point in the home network to set up port forwarding rules. An IGD or other device may also support remote administration of port forwarding via the external network interface. Even where port forwarding can be automatically set up, users may desire to be informed of what is happening and be given the opportunity to prevent port forwarding from being enabled and/or control how and when it is set up. This is because port forwarding may expose home computers to direct access from the Internet, therefore should be used sparingly and with an understanding of potential risks.

Another issue with port forwarding is that it requires different addressing of home devices depending on location of client (home or outside). For example, assume a user has a file server named “media-store” with IP address 192.168.1.102 that is accessed via SMB over TCP port 445. The local name may be resolved on the home network using a local DNS server or NetBIOS. In addition, the user has a gateway with external IP address 1.1.1.102 that is mapped by Internet DNS to “homeuser102.myisp.com.” The gateway may be set up to map TCP port 445 on interface 1.1.1.102 directly to the same port on the 192.168.1.102 when forwarding incoming traffic.

The gateway may use other mappings instead of or in addition to this straightforward mapping of one incoming port to the same port of an internal computer. For example, the gateway described above may have incoming connections at 1.1.1.102:44555 mapped to 192.168.1.102:445 instead of or in addition to the mapping described above. The use of alternate port mappings is particularly useful if there are two or more devices on the home network using the same port. For example, if host1 and host2 are on the local network and both are running web servers on port 80, host1 can be mapped to external port 80, and host2 can be mapped to external port 81, thereby allowing both hosts to be externally accessed from the same external IP address.

In this example network, the user may have a portable device with an application that gets data (e.g., streams music files) from “smb://media-store” when in the home network. When outside the home network, the application would have to be reconfigured to access the same media at “smb://homeuser102.myisp.com” (or “smb://homeuser102. myisp.com:444555” if the alternate port mapping discussed above is used). This could be required for a number of applications (e.g., browsers, media players, messaging clients, etc.), all of which may have different ways of configuring access to network services (e.g., bookmarks, configuration settings, etc.). As such, it could be confusing for the end user to determine how to remotely access the home network for different applications.

Nonetheless, the use of port forwarding at the gateway has many positive points, even if different addressing schemes may be needed depending on location. Therefore, a gateway and a mobile client device according to the invention interact so that the client can be made aware of the home network configurations, such as by querying the home gateway about all port forwarding mappings. When the client device is later outside the home network, the client automatically detects this condition and chooses an alternate address/port for a service of the private network. The gateway receives these requests and automatically forwards traffic to the appropriate port and IP address of the private network. Thus, user doesn't notice any difference when moving from the home network to outside the home network.

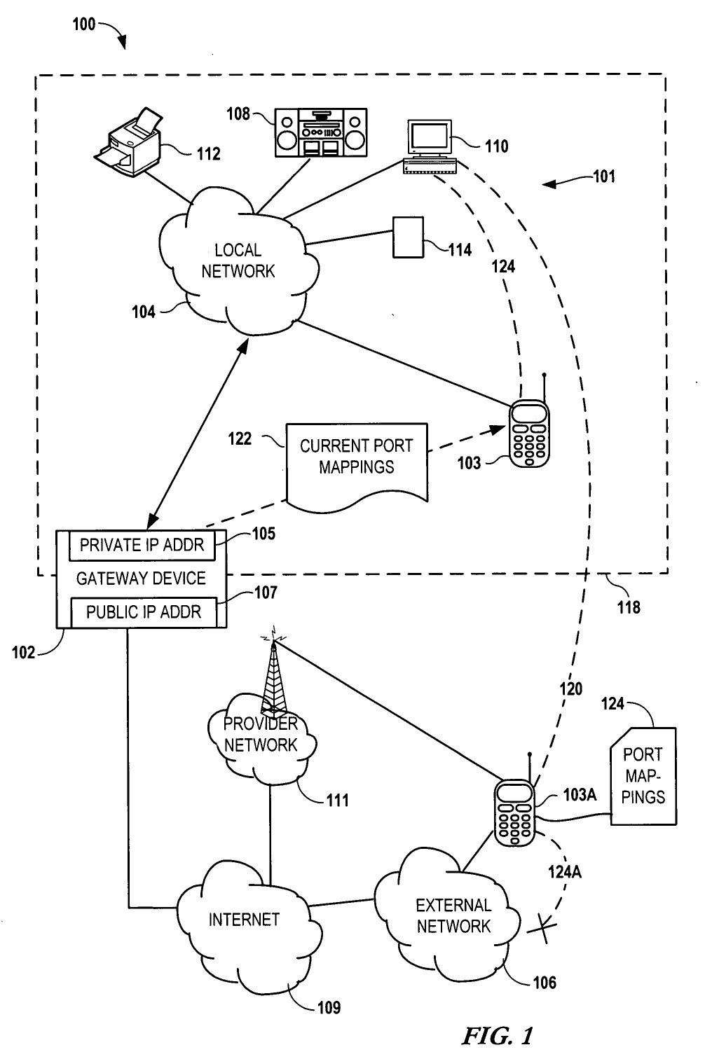

In reference now to FIG. 1, a block diagram illustrates a system 100 having a gateway device 102 and user device 103 according to embodiments of the invention. The gateway device 102 is coupled to both a local network 104 and a wide or global area network, e.g., the Internet 109. The local network 104 is typically designed to service a limited physical region, as indicated by the physical region 118. This region 118 may include any space where a user would like devices to easily interoperate, including a home, office, hotel room, automobile, airplane, boat, public wireless hotspot, etc. The protocols used in the local network 104 (e.g., UPnP) may assume that the network 104 will need to support only a limited number of devices operating within a reasonably small area.

The local network 104 may include any combination of data transmission media and protocols. For example, the network 104 may utilize wired or wireless data transmission media. Similarly, devices on the local network 104 may use various physical and data link layer protocols to intercommunicate, including Ethernet, FDDI, PPP, ATM, HDLC, Fibre Channel, X-10, serial/parallel point-to-point connections, etc. A number of higher layer network protocols may operate on the network 104 as well, including TCP/IP, UDP/IP, IPX, Appletalk, ICMP, ARP, SNMP, DNS, FTP, HTTP, NetBEUI, etc.

In some arrangements, the local network 104 may support one or more protocols for ad-hoc, peer-to-peer service discovery and interoperability. One example of this type of protocol is the Universal Plug and Play (UPnP) architecture. UPnP uses the Simple Service Discovery Protocol (SSDP) for service discovery, and is generally built on top of IP-based networks. Although some embodiments of the present invention may be described in terms of UPnP implementations, those familiar with the applicable art will appreciate that these concepts may be applied to any manner of traditional client-server arrangements, or to other ad-hoc, peer-to-peer networking arrangement suitable for consumer oriented networks. For example, the present invention may also be implemented using any combination of home networking and control technologies such as Jini, Bluetooth, X-10, xAP, Rendezvous, HomeRF, IrDA, etc.

In cases where the local network 104 uses an ad-hoc, peer-to-peer networking protocol such as UPnP, the gateway 102 may also be adapted to use that protocol. Protocols such as UPnP are designed to be generic and flexible so that any type of control or data processing functionality can be abstracted and offered as a service to any other UPnP capable entity on the network 104. In particular, the gateway 102 may be configured as a UPnP compatible device known as an Internet Gateway Device (IGD). The IDG is a UPnP device that provides zero configuration Internet access to any UPnP compatible devices 101 on the local network 104.

The local network 104 may couple together a number of consumer devices 101, such as a mobile communications device 103, an entertainment system 108, computer 110, printer 112, smart appliance 114, etc. These devices 108, 110, 112, 114 are merely exemplary; any manner of electronic or electromechanical device may be made network-aware and interoperate via the local network 104. The devices 101 may interact with one another in an ad-hoc, peer-to-peer fashion, and may also benefit from information services externally available via the Internet 109.

The mobile communications device 103 may include a mobile terminal such as a cellular phone, media player, personal digital assistant, navigation unit, etc. The device 103 is designed to be portable, and thus would generally include the ability to connect to the local network 104 when in the local region 118, and connect to one or more external networks 106, 111 when outside the region 118 (as represented by device with reference number 103A). The external network 106 may include a native IP wired or wireless network, such as a WiFi hotspot, workplace local area network (LAN), etc. The other network 111 may be a mobile services provider network that is adapted to carry IP traffic. An example of this type of network 111 is a cellular communications network having third-generation (3G) data services that provides Internet access for mobile device 103A.

Whether communicating via the local network 104 or remote network 106, the mobile communications device 103, 103A may access the gateway 102, which is capable of being simultaneously connected to two networks 104, 109. The gateway device 102 may perform any combination of functions, including that of a router, firewall, bridge, gateway, adapter, modem, wireless access point, or any other element that handles data transfers occurring between two or more network interfaces. The gateway device 102 may connect to an Internet Service Provider (ISP) via Ethernet, Digital Subscriber Line (DSL), Asymmetric DSL (ADSL), Home Phoneline Networking Alliance (Home PNA) etc. The gateway 102 may provide other services to the local network 104, such as automatic device configuration using Dynamic Host Configuration Protocol (DHCP), IP address lookup using Domain Name Service (DNS) and/or NetBIOS, etc.

While in the local network 104, the mobile device 103 may use the gateway 102 as a default route to access the Internet 109. In many cases, the gateway device 102 uses Network Address Translation (NAT) for providing Internet connectivity to multiple home devices 101, 103 coupled to the local network 104. The home devices 101, 103 may be assigned private IP addresses (e.g. 192.168.x.y) that are not routable from the public Internet 109. In such a case, the gateway 102 also has a private address 105 that the gateway 102 uses to communicate with local devices 101, 103. The gateway 102 also includes a publicly routable IP address 107 where the device 102 connects to the Internet 109 The public IP address 107 may be static or dynamically assigned by the ISP using a protocol such as DHCP.

While coupled to the external networks 106, 111, the device 103A may also try to access the gateway 102 via the Internet 109 in order to access services provided by devices 101 of the local network 104. If the gateway 102 is set up as a firewall, the gateway 102 may reject all requests originating from the Internet 109 unless there have been explicit port mappings to redirect incoming connections to a particular local device 101. The gateway 102 may also handle requests on its own, such as where the gateway provides a VPN interface. In that case, the VPN interface receives incoming VPN connection requests and facilitates creating a tunnel between the device 103A and the local network 104. The gateway 102 can be preconfigured to handle incoming connections, typically ignoring connection requests by default unless explicitly configured to do otherwise. When the gateway 102 implements NAT, the gateway 102 may also translate between private and public address spaces for those connection requests that are handled by way of port mapping.

In one scenario, it may be that the device 103A, while coupled to external network 106, wishes to access a home network service, such as retrieving a file from home computer 110 (represented by path 120). For relatively simply services such as FTP or SMB, the retrieval 120 may be accomplished using a single socket connection and facilitated by the gateway 102 through the use of port mapping. Other services may require multiple sockets. For example, the Session Initiation Protocol (SIP) is an application protocol that facilitates, among other things, engaging in real-time, end-to-end media sessions such as video and audio. In some scenarios, the SIP signaling data may be sent by way of one or more UDP/IP or TCP/IP channels/connections, and the media itself may use a different UDP/IP or TCP/IP channels/connections. Another example includes UPnP, which may use SSDP over multicast channels for service discovery, and ad hoc data sessions may take place over other unicast, multicast, or broadcast data channels. These communications can use multiple predetermined port mappings on the gateway 102 to achieve the communications, assuming that the particular necessary ports are known beforehand.

In some scenarios, external access to the home network 104 by the device 103A may need to take into account additional factors besides the different addressing between internal and external networks 104, 106, 109, 111. For example, some forms of traffic such as multicast data may not be available at all via the Internet 109 or external networks 106, 111. Although many routers are capable of passing multicast traffic, most ISPs turn this feature off. Therefore, protocols that require broadcast or multicast IP traffic might not be usable over the Internet 109 without particular adaptations. Therefore, the device 103A may need to take other factors into account when trying to access the local network 104 from a remote network 106.

In the illustrated system 100, the gateway device 102 may be a NAT gateway that allows mapping of connections received at the public IP address 107 to services available via the local network 104. The user device 103 is able to automatically determine port mappings 122 of the gateway 102 while coupled to the local network 104. The term “port mappings,” as it is used herein, may refer to any combination of address, port, and other network data needed to allow a local service to be accessed from an external network, typically via a NAT gateway. These mappings 122 may be currently in effect, or may be currently turned off. In the latter case, it may be assumed that the device 103 may be able to automatically enable the mappings 122, either while the device 103 is in the local region 118, or while located remotely. In other arrangements, enabling of the mappings 122 may occur automatically (e.g., based on time of day), occur in response to explicit signals from any number of user devices, and/or result from out-of-band communications from device 103 (e.g., via a short message service communication sent via cellular data networks 111).

While the device 103 is coupled to the local network 104, the device 103 can directly access the computer 110 (as indicated by path 124) without the use of the mappings 122. However, if the device 103A is outside the home region 118 and coupled to network 106, the device 103A may try accessing the same computer 110 using the same parameters (e.g., IP address and port) that was used in the connection 124 in the home region 118. This attempt may fail, as indicated by path 124A. The connection failure indicated by path 124A may involve a number of different occurrences. The external network 106 may use a different network address/netmask than the local network 104, in which case the connection request 124A may not be routable. If the network address/netmask of the external network 106 is the same as the local network 104, there may or may not be machines on the external network 106 having the same address as computer 110. If there are no machines on external network 106 having the same address as computer 110, there is no response to the request 124A. If there is a machine (not shown) on external network 106 having the same address as computer 110, this external machine may or may not have the same service running that is target of request 124A. In either event, this external machine is not the computer 110 to which device 103A wishes to connect, and therefore whether connection 124A is accepted or not by the external machine, it is not “successful” in that it is not a connection to the desired target 110. Because of this latter scenario, it may be preferable to determine whether device 103A is outside the local network 104 (e.g., identifying home WLAN SSID) before attempting to connect 124A to the private address of computer 110.

Before making connection attempt 124A, the device 103A may determine whether it is on a remote network 106. If so, the device 103A may use parameters of the connection attempt 124A (e.g., target IP address and TCP/UDP port) to look up alternate parameters in the stored port mappings 126 that were previously obtained from the gateway 102. If a mapping is found, the device 103 can modify the connection attempt using the external IP address 107 of the gateway 102, and apply any other necessary adaptations needed for external access (e.g., use of alternate protocol). In this way, the device 103A can connect 120 to the computer 110 without the user having to set up the mappings 124 or to reconfigure an application to use the mappings 124.

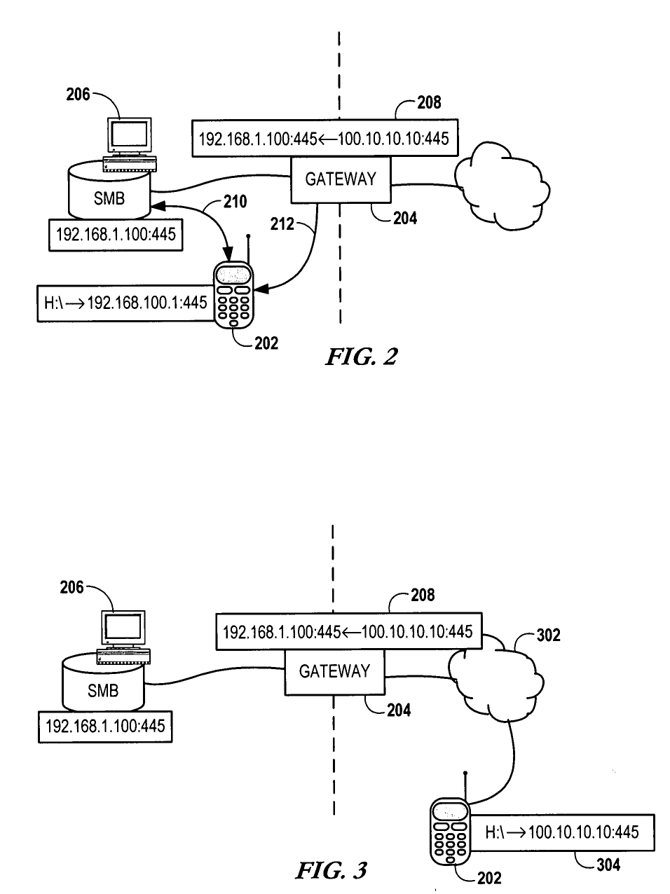

In reference now to FIGS. 2-3, a scenario illustrates how a mobile client device 202 and gateway 204 may handle external port mapping according to an embodiment of the invention. The user has an SMB server 206 running at 192.168.1.100 (port 445). The user also wants to have the service 206 accessible externally, so makes a port mapping 208 on the gateway 204. Although the external address in the mapping 208 is shown as an IP address, it will be appreciated that the external address may use a hostname and/or URL accessible via DNS, Dynamic DNS, proxy, forwarder, etc. The user mounts the server 206 (e.g., using path \\192.168.1.100) to drive H:\ on the mobile device 202, and thereafter applications of the device 202 can access 210 data stored at drive H:\. The mobile device 202 also contacts the home gateway 204 and retrieves 212 the port mappings 208. The device now knows the mappings 208, and saves them locally.

The device 202 and gateway 204 may communicate 212 the mappings in a number of different ways. If the device 202 and gateway 204 are UPnP capable, then the mappings may be obtained from state data communicated from an IGD interface on the gateway 204. The IDG interface may implement a UPnP remote procedure call to get all port forwarding mappings of the gateway. In such a case, the mobile device 202 may implement a UPnP Control Point interface. The IDG interface may also allow the device 202 to subscribe to change events regarding the port mapping, so that the Control Point interface of device 202 can be notified of port mapping changes as soon as they occur.

There may be other ways for the port mapping data to be communicated 212 to the mobile device 202. Such communications may involve proprietary protocols, or use an open and standardized format to enable different mobile devices 202 to work with different gateways 204. As an example of the latter, commercially available gateways 204 typically include a web-based configuration interface (e.g., HTML documents and forms provided by an internal HTTP server). Although these interfaces tend to vary by manufacturer, compliant devices may include a common URL (e.g., http://gateway-ipaddress/standard/port_map.xml) and data format (e.g., HTML or XML document using standardized tags) that will allow any device to automatically determine the port mappings 208.

In FIG. 3, the mobile device 202 has moved to an external network 302. The same application tries to access the drive H:\ again, but the mobile device 202 notices that the address of the server 206 (192.168.1.100) is not accessible, typically by determining that network 302 is different than the private network. In response, the mobile device 202 remounts the drive H:\ to the saved port mapping 208 that was previously provided by the gateway 202 as shown in FIG. 2. In this example, this results in H:\ being mapped 304 to 100.10.10.10:445 (automatically or after prompting the user). The mobile device 202 then accesses the gateway 204 at the address:port 304 determined from the mapping 208, and the gateway 204 forwards the traffic to the file server 206.

As described above, the mobile device 202 determines that the device 202 is not on the home network before servicing a connection request targeted to an address of the home network. The mobile device 202 may use a number of techniques, either alone or in combination, to determine whether it is outside the local network. Such a determination may be made before and/or after a content request is made. For example, the device 202 could examine its current IP address and see if the address corresponds to a valid address on the home network. However, many different local networks may use the same network identifier (e.g., 192.168.1.0/24). In such a case, additional checks may be needed to see if the device 202 is on the home network even if the network portion of the current IP address corresponds to the home network.

When a WiFi connection is used by device 202, another way of identifying whether the device is outside the home network is to compare a current Wireless Local Area Network (WLAN) access point (AP) service set identifier (SSID) with the SSID of the home network. This may result in fewer false positives than use of network identifier, because SSIDs tend to be more varied. Users are asked to provide an SSID during WLAN setup, and generally choose something of significance to them. Still, an SSID need not be globally unique, and many times users will accept the default name or use something generic such as “home.” Therefore it still may be the case that a home and remote WiFi network have identically named SSIDs.

A mobile device 202 according to embodiments of the invention may use a combination of network information to determine whether or not it is currently on its home network. For example, such information as DNS server IP address, default route, WINS server address, Media Access Control ID of gateway or WLAN AP, etc., may be used alone or in combination to determine whether or not the user is on the home network. It will be appreciated that these indicia may change on the home network, albeit infrequently. For example, a number of variables may change (e.g., MAC ID, network identifier portion of IP addresses) when the user replaces various networking devices such as routers, gateways, switches, APs, modems, etc. As such, a comparison of a number of network parameters may be useful to detect if one particular infrastructure device has been replaced or reconfigured. In such a case, the user may be prompted if some variables change while others stay the same, so that the configuration state of the home network can be updated on the mobile device 202.

A mobile device 202 according to an embodiment of the invention may also use other data that is not directly related to the network configuration to determine whether the device 202 is away from the home network. For example, as previously described, the inability to reach a desired server (e.g., server 206) may be enough in and of itself to determine that the user is away from the home network. However, the same situation may exist where the server 206 is inoperative, and therefore this by itself may not always indicate whether or not the user is on the home network. One reliable indicator of whether the mobile device 202 is on the home network is the location of the mobile device 202. This location can be read directly, e.g., where a device 202 include a Global Positioning Satellite receiver. This location can also be indirectly derived, e.g., by determining a listing of available cellular base stations and seeing if any match the base stations near the user's home.

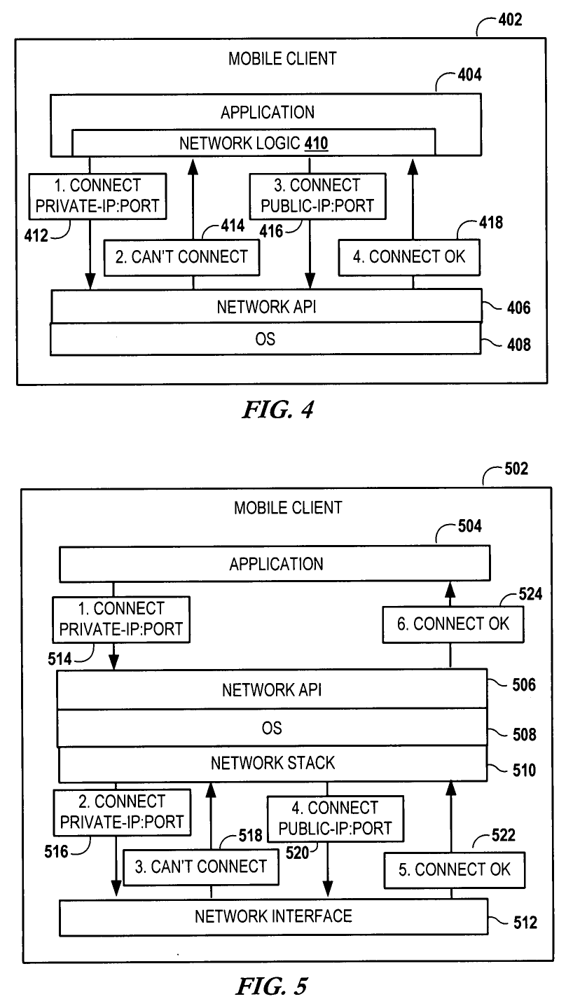

As described above, the mobile device 202 can be configured to modify a private network connection request to utilize an external address when it is determined that the device 202 is no longer on the private network. In reference now to FIG. 4, a block diagram illustrates one way that this may be implemented in a mobile client device 402 according to an embodiment of the invention. The client 402 includes a network application 404 that accesses a network via a network application program interface (API) 406 of an operating system (OS) 408. In this implementation, the application 404 includes network logic 410 that deals with the automatic switching between private and public addresses.

In the illustrated arrangement 402, the application 404 tries to connect 412 to the private address, either automatically in response to a user initiated request. In response to the connection 412, the network API 406 and or application 404 signal 414 that the connection attempt cannot be made. The signal 414 may be in response to an actual failure, or may be a determination made by way of the network logic 410 and/or network API 406 that the device 402 is not on the private network. In response to the signal 414, the application logic 416 attempts the connection using the public address and port, which is successful 418. Although the illustrated scenario 400 shows the “can't connect” signal 414 as the triggering event for trying the alternate connection 416, it will be appreciated that network data may be gathered at any time and used to determine that the device is outside the private network, as described in greater detail above. This data could be gathered at the time of the request 412 or at some other time. For example, the network logic 410 could repeatedly poll the network API 406 to determine the current state of the network, and select the appropriate connection parameters 412, 416 in response to the request 412 without waiting for or utilizing signal 414.

A block diagram in FIG. 5 illustrates an alternate implementation of address selection in a mobile client terminal 502 according to an embodiment of the invention. The terminal 502 includes an application 504, network API 506, and OS 508 similar to like-named components described in FIG. 4, except that the application 504 does not include internal logic to determine whether or not the terminal 502 is on a private network. Instead, the terminal 502 includes a modified network stack 510 that interfaces with network interface hardware/firmware 512. In this arrangement 502, the application 504 requests 514 a connection on the private address and port, and this is attempted 516 by the network stack 510. A signal 518 indicates that the connection 516 may fail. Signal 518 may be due to an actual connection failure, or may be a determination made by way of the network components 510, 512 that the device 502 is not currently on the private network. In this case, the network stack 510 intercepts the signal 518 and independently tries a connection 520 using the public address. Assuming success 522, the application 504 obtains the connection 524 without having to know about the modification of the request 514.

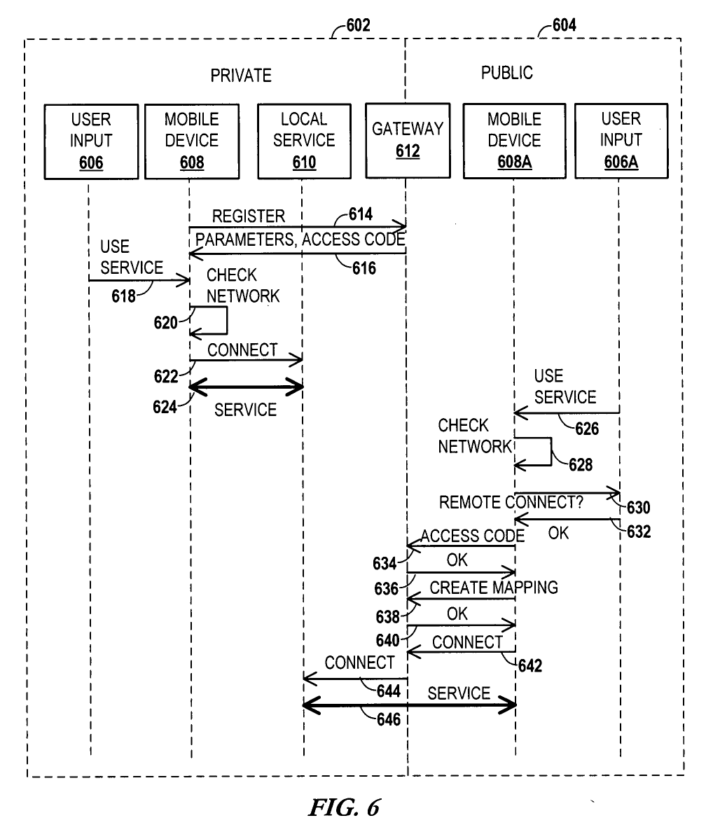

In reference now to FIG. 6, a sequence diagram illustrates additional features for remotely accessing private networks according to embodiments of the invention. This diagram illustrates interactions between devices on a private network 602 and a public network 604. The denotation of “private” and “public” in this content generally indicates that a gateway 612 allows connection requests to freely go one direction (e.g., from private 602 to public 604 networks) but highly regulates connection requests in the other direction. The private network 602 and gateway 612 may utilize technologies such as NAT, but the present invention may be applicable in other situations. For example, the private network 602 may utilize publicly routable IP addresses, and the gateway 612 is a router that merely blocks incoming connections to nodes on the private network 602. In such a case, the gateway 612 may allow connections to be routed under some conditions, but without remapping addresses and ports.

The private network 602 includes a local service 610 that may be accessed by a mobile device 608 generally in response to user input 606. The user input 606 may include any combination of user applications, input/output hardware, remote network commands to control device 608, etc. The mobile device 608 and user input 606 may located at one of the private and public networks 602, 604 at any given time, the latter being indicated by way of reference number 606A and 608A. The gateway 612 has the ability to connect to both networks 602, 604 simultaneously.

Before ever receiving any user commands, the mobile device 608 may be able to register 614 with the gateway 612 (or similar device in the private network 602). This registration 614 may be at least a request for current port mapping, and may involve determining additional states and data related to both the gateway 612 and mobile device 608. In this example, the gateway returns 616 port mappings and an access code that the mobile device 608 may use to enable or disable certain port mappings. For example, the gateway 612 may disable the port mappings until such time as the mappings are needed, e.g., when the device 608A is on the public network 604.

Thereafter, the mobile device 608 may receive a request 618 to use a service, e.g., from the user input 606. The device 608 checks 620 to determine whether the device 608 is on the private network 602 or public network 604. The device determines 620 that it is on the private network 602, and so commences to connect 622 and use the service 624 using local network protocols and identifiers. At a later time, a similar sequence of service request 626 and network determination 628 occurs via the user input 606A and device 608A while on the public network 604. In this case, the device 608A determines that it is on the public network 604, and may optionally prompt 630 the user in order to verify 632 that it is acceptable to remotely connect via the gateway 612.

In response to the connection request 626, 632, the mobile device 608A will connect 642 via the gateway 612, which forwards 644 the connection and facilitates establishing the service 646. The gateway 612 and mobile device 608A may also engage in additional exchanges before allowing the connection 642 to be processed. For example, the device 608A may authenticate 634, 636 with the gateway 612 using the access code that was previously provided to the device at registration 616. In addition, the mobile device 608A may signal 638, 640 to the gateway 612 a command to activate/create port mappings needed to access the requested service 646. The mobile device 608A may similarly send signals (not shown) that remove the mappings after the service session 646 has ended, thereby preventing intruders from attempting to connect to this port.

It will be appreciated that the detection of the network 620, 628, may serve other purposes besides dictating the addresses used for connecting 622, 642 to the target service. For example, the mobile device 608 may include UPNP functionality. On the private network 602, the use may wish that the mobile device 608 engage in SSDP service discovery, as well as advertise services using SSDP. However, in the public network 604, it may be preferable for the device 608A to shut off all UPnP interfaces to prevent a network attack via those interfaces. Similarly, the mobile device 608 may utilize the service 610 on the private network 602 without needing to worry about data privacy of the session 624. However, on the public network 604, the mobile device 608A may prefer that all communications with the service 610 be encrypted. In some cases, the service 610 may offer alternate secured and unsecured transport mechanisms (e.g., HTTPS versus HTTP). In other cases, the service 610 or gateway 612 may allow traffic to be tunneled through a secure session (e.g., via secure sockets layer or secure shell).

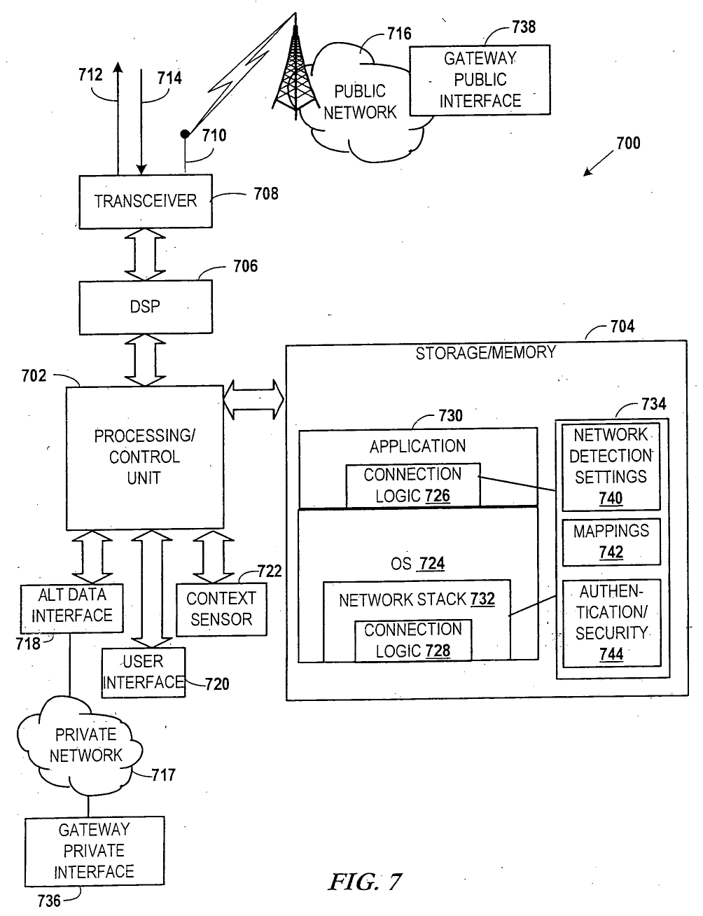

Any type of computing device may benefit from determining whether it is on a private or public network as described herein. Mobiles device may regularly transition between private and public networks and therefore benefit from implementations of the present invention. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 is shown with wireless network circuitry such as a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The incoming and outgoing radio signals 712, 714 may be used to communicate with a public network 716 and/or a private network 717. The public network 716 may include any voice and data communications infrastructure known in the art, including CDMA, W-CDMA, GSM, EDGE, etc. The network 716 typically provides access to traditional landline data infrastructures, including IP networks such as the Internet. The mobile computing arrangement 700 may also include an alternate network/data interface 718 capable of accessing one or both of the networks 716, 717. The alternate data interface 718 may incorporate combinations of I/O and network standards such as USB, Bluetooth, Ethernet, 802.11 Wi-Fi, IRDA, etc. The private network 717 may implement any manner of data transfer technology, including ad-hoc, peer-to-peer data exchanges (exemplified by UPnP). It will be appreciated that the alternate data interface 718, transceiver 708, and DSP 706 may be part of a single hardware component, or may be separate device. Any combination of these components 706, 708, 718 may be capable of communicating with one or both of the networks 716, 717.

The processor 702 is also coupled to user-interface elements 720 associated with the mobile terminal. The user-interface 720 of the mobile terminal may include, for example, a display such as a liquid crystal display. Other user-interface mechanisms may be included in the interface 720, such as keypads, speakers, microphones, voice commands, switches, touch pad/screen, graphical user interface using a pointing device, trackball, joystick, etc. The arrangement 700 may include other sensors, as represented by context sensor 722, which may detect certain environmental conditions such as location. These and other hardware/software components are coupled to the processor 702 as is known in the art.

The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The program storage/memory 704 typically includes operating systems 724 for carrying out functions and applications associated with functions on the mobile computing arrangement 700. The storage/memory 704 of the mobile computing arrangement 700 may also include software modules for performing functions according to embodiments of the present invention.

In particular, the program storage/memory 704 may include one or both of first and second connection logic modules 726, 728. These modules 726, 728 enable the computing arrangement 700 to detect whether the arrangement is currently connected to the public network 716 or the private network 717. First connection logic module 726 is an application-level implementation, and may be included in one or more applications 730. Second connection logic module 728 is implemented as part of a network stack 732, which may be included as part of the operating system 724. The connection logic modules 726, 728 may operate independently or interdependently. Generally, where the logic is implemented within the network stacks 732 (or elsewhere in the OS 724) as is module 728, the applications 730 may not need to include any additional logic 726 to take advantage of the network features described herein.

Typically, the modules 726, 728 will manage data 734 related to connecting via a gateway. In particular, the modules 726, 728 may communicate with a private interface 736 of a gateway while on the private network 717, and communicate with a public interface 738 of the gateway when on the public network 716. One or more of the modules 726, 728 allow the applications 730 to automatically and transparently access a service of the private network 717 regardless of whether the arrangement 700 is currently coupled to the private network 717 or one or more public networks 716.

The managed data 734 may include network detection settings 740, which describe characteristics of the private network 717 and may be used to determine whether the arrangement is currently located on the private network 717 or public network 716. The detection settings 740 may be created during initial network setup and/or be created and modified by the user. The detection settings 740 may include a number of network parameters to be analyzed to increase the accuracy of the detection. Using multiple parameters also allows detecting the home network if some of the network parameters (e.g., network portion of IP addresses, subnet mask) to be changed while others (e.g., SSID, gateway MAC address) remain the same. In this way, the user does not have to reconfigure the settings 740 every time an incremental change is made on the private network 717. The detection settings 740 may also define non-network related parameters that may be used to detect whether or not the current network is private, such as by detecting location (or some other context) from context sensor 722.

The managed data 734 may also include mappings 742 that are used by public interface 738 of the gateway to pass connections through the gateway to the private network 717. These mappings 742 may include TCP or UDP port mappings, and may include other data such as alternate transport protocols for public/private access, authentication mechanisms, etc. The mappings 742 may be independently determined by the arrangement 700 and/or be communicated to the arrangement 700 from the private interface 736 of the gateway. The mappings 742 may also include data that allows the arrangement 700 to disable/enable mappings through either interface 736, 738 of the gateway. Finally, the data 734 may include authentication/security data 744 that typically is used to access the public interface 738, but may also be used on the private network 717 as well. The authentication/security data 734 may include user defined passwords, gateway-generated passcodes, shared cryptographic keys, etc.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

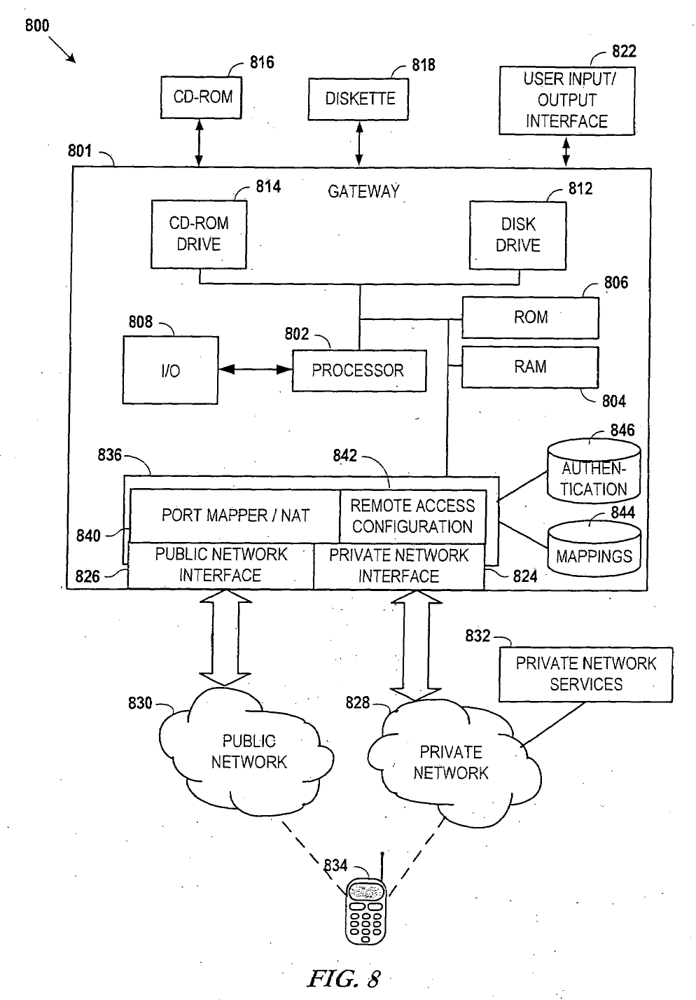

The mobile computing arrangement 700 may be used to access the private network via a gateway. Gateway devices provide a link between the home computing/automation environment and the public data networks. In reference now to FIG. 8, a block diagram illustrates example gateway 800 according to an embodiment of the invention. The gateway 800 includes a computing arrangement 801. The computing arrangement 801 may include custom or general-purpose electronic components. The computing arrangement 801 includes a central processor (CPU) 802 that may be coupled to random access memory (RAM) 804 and/or read-only memory (ROM) 806. The ROM 806 may include various types of storage media, such as programmable ROM (PROM), erasable PROM (EPROM), etc. The processor 802 may communicate with other internal and external components through input/output (I/O) circuitry 808. The processor 802 carries out a variety of functions as is known in the art, as dictated by software and/or firmware instructions.

The computing arrangement 801 may include one or more data storage devices, including hard and floppy disk drives 812, CD-ROM drives 814, and other hardware capable of reading and/or storing information such as DVD, etc. In one embodiment, software for carrying out the operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to computing arrangement 801 via data signals, such as being downloaded electronically via a network, such as the Internet. The computing arrangement 801 may be coupled to a user input/output interface 822 for user interaction. The user input/output interface 822 may include apparatus such as a mouse, keyboard, microphone, touch pad, touch screen, voice-recognition system, monitor, LED display, LCD display, etc.

The computing arrangement 801 may be coupled to other computing devices via networks. In particular, the computing arrangement includes network interfaces 824, 826 capable of interacting with respective local “private” networks 828 and external “public” networks 830. The network interfaces 824, 826 may include a combination of hardware and software components, including media access circuitry, drivers, programs, and protocol modules. Ultimately, the computing arrangement 801 may be configured to allow network services 832 of the private network 828 to be accessed by client device 834 when the client device 834 is coupled to the external networks 830.

The computing arrangement 801 includes processor executable instructions 836 for carrying out tasks of the computing arrangement 801. These instructions 836 may include a port mapping module 840 capable of providing access to local services 832 via the external networks 830. The port mapping module 840 may provide other features besides basic port mapping, such as NAT translation, authentication of the accessing client terminal 834, end-to-end data encryption between the public interface 826 and the terminal 834, remote enabling/disabling of the port mapping, etc. While on the private network 828, the client terminal 834 may also determine various parameters related to the port mapping module 840 by way of a remote access configuration module 842. The configuration module 842 may communicate data to the client terminal 834 that enables the terminal 834 to determine whether or not the current network is private 828 or public 830, discover predetermined mappings 844 used by the mapping module 840, receive/set authentication data 846, etc. Authentication data 846 may be used by both client 834 and gateway 800 for remote access, remote port mapping management, data encryption, etc.

The gateway 800 is only a representative example of network infrastructure hardware that can be used to provide services as described herein. Generally, the functions of the gateway 800 can be distributed over a two or more of processing and network elements, and can be integrated with other services, such as service enablers, routers, mobile communications messaging, etc.

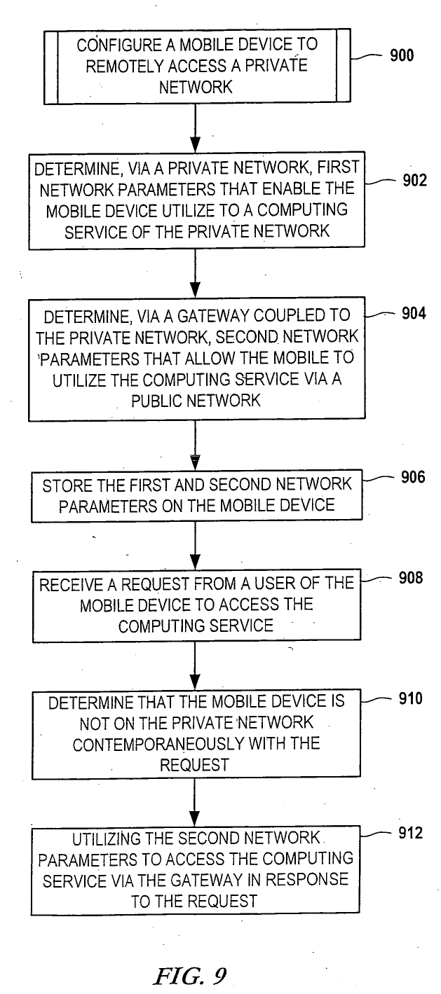

In reference now to FIG. 9, a flowchart illustrates a procedure 900 for configuring a mobile device to remotely access a private network. The device determines 902, via a private network, first network parameters that enable the mobile device utilize to a computing service of the private network. The device also determines 904, via a gateway coupled to the private network, second network parameters that allow the mobile to utilize the computing service via a public network. Generally, the gateway selectably blocks connection attempts from the public network to the private network. The first and second network parameters are stored 906 on the mobile device. A request is received 908 from a user of the mobile device to access the computing service. It is determined 910 that the mobile device is not on the private network contemporaneously with the request. In response to determining that the mobile device is not on the private network, the second network parameters are utilized 912 to access the computing service via the gateway in response to the request.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus comprising:
at least one network interface, memory, and a processor coupled to the memory and the network interface, wherein the memory stores instructions that causes the processor to:
while on the private network:
determine first network parameters that enable the apparatus to utilize a computing service of the private network;
determine, from a gateway coupled to the private network and the public network, second network parameters that allow the apparatus to utilize the computing service via the public network, wherein the gateway selectably blocks connection attempts from the public network to the private network; and
while on the public network:
receive a request from the user interface to access the computing service;
determine that the apparatus is not on the private network; and
utilize the second network parameters to access the computing service via the gateway in response to determining that the apparatus is not on the private network.

2. The apparatus of claim 1, wherein the instructions cause the processor to determine that the apparatus is not on the private network by comparing network configuration parameters received via the public network to analogous network configuration parameters of the private network.

3. The apparatus of claim 2, wherein comparing network configuration parameters received via the public network comprises analyzing current Internet protocol configuration data of the network interface to determine that the current Internet protocol configuration data is different than Internet protocol configuration data of the private network.

4. The apparatus of claim 2, wherein comparing network data received via the network interface comprises analyzing a current service set identifier of a wireless access point to determine that the current service set identifier is different than a service set identifier of the private network.

5. The apparatus of claim 1, wherein the instructions cause the processor to determine that the apparatus is not on the private network by determining a location of the apparatus.

6. The apparatus of claim 1, wherein the private network comprises a Universal Plug and Play network, and wherein the apparatus determines the second network parameters from a Universal Plug and Play Internet Gateway Device interface of the gateway.

7. The apparatus of claim 1, wherein the instructions cause the processor to determine that the apparatus is not on the private network in response to a failure of a connection attempt made using the first network parameters.

8. The apparatus of claim 1, wherein the gateway comprises a network address translation gateway, and wherein the second network parameters comprise an IP address and port mapping usable by the network address translation gateway.

9. A method comprising:
determining, via a private network, first network parameters that enable the mobile device utilize to a computing service of the private network;
determining, via a gateway coupled to the private network and the public network, second network parameters that allow the mobile to utilize the computing service via the public network, wherein the gateway selectably blocks connection attempts from the public network to the private network;
storing the first and second network parameters on the mobile device;
receiving a request from a user of the mobile device to access the computing service;
determining that the mobile device is not on the private network; and
utilizing the second network parameters to access the computing service via the gateway in response to the request and in response to determining that the mobile device is not on the private network.

10. The method of claim 9, wherein determining that the mobile device is not on the private network comprises comparing current network configuration parameters received via the public network with analogous network configuration parameters of the private network.

11. The method of claim 10, wherein comparing network configuration parameters received via the public network comprises analyzing current Internet protocol configuration data of the network interface to determine that the current Internet protocol configuration data is different than Internet protocol configuration data of the private network.

12. The method of claim 10, wherein comparing network configuration parameters received via the public network comprises analyzing a current service set identifier of a wireless access point to determine that the current service set identifier is different than a service set identifier of the private network.

13. The method of claim 9, wherein determining that the apparatus is not on the private network comprises determining a location of the apparatus.

14. The method of claim 9, wherein the private network comprises a Universal Plug and Play network, and wherein the second network parameters are determined from a Universal Plug and Play Internet Gateway Device interface of the gateway.

15. The method of claim 9, wherein determining that the apparatus is not on the private network comprises determining a failure of a connection attempt made using the first network parameters.

16. The method of claim 9, wherein the gateway comprises a network address translation gateway, and wherein the second network parameters comprise an IP address and port mapping usable by the network address translation gateway.

17. A system comprising:
a gateway capable of being simultaneously coupled to a private network and a public network, wherein the gateway selectably blocks connection attempts from the public network to the private network; and
a mobile terminal capable of communicating on the private network public networks, the mobile terminal comprising:
at least one network interface;
memory; and
a processor coupled to the memory and the network interface, wherein the memory stores instructions that causes the processor to:
while on the private network:
determine first network parameters that enable the mobile terminal utilize to a computing service of the private network;
determine, via the gateway, second network parameters that allow the mobile terminal to utilize the computing service via the public network; and
while on the public network:
receive a request to access the computing service;
determine that the mobile terminal is not on the private network; and
utilize the second network parameters to access the computing service via the gateway in response to determining that the apparatus is not on the private network.

18. The system of claim 17, wherein the private network comprises a Universal Plug and Play network, and wherein the second network parameters are determined from a Universal Plug and Play Internet Gateway Device interface of the gateway.

19. A computer-readable storage medium including instructions executable by a processor of a mobile terminal for:
while on a private network:
determining first network parameters that enable the mobile terminal to utilize a computing service of the private network;
determining, from a gateway coupled to the private network and the public network, second network parameters that allow the mobile terminal to utilize the computing service via the public network, wherein the gateway selectably blocks connection attempts from the public network to the private network; and
while on the public network:
receiving a request from the user interface to access the computing service;
determining that the mobile terminal is not on the private network; and
utilizing the second network parameters to access the computing service via the gateway in response to determining that the apparatus is not on the private network.

20. An apparatus comprising:
means for determining, while on a private network, first network parameters that enable the apparatus to utilize a computing service of the private network;
means for determining, while on the private network from a gateway coupled to the private network and a public network, second network parameters that allow the apparatus to utilize the computing service via the public network, wherein the gateway selectably blocks connection attempts from the public network to the private network;
means for receiving, while on the public network, a request from a user of the apparatus to access the computing service;
means for determining that the apparatus is not on the private network while on the public network; and
means for utilizing the second network parameters to access the computing service via the gateway in response to determining that the apparatus is not on the private network.
